(19) United States
(12) Patent Application Publication
(10) Pub. No.: US 2013/0305933 A1
(43) Pub. Date: Nov. 21, 2013

(54) ELECTRONIC MODULE FOR TEMPERATURE-MONITORED PREPARATION OF FOOD IN A COOKING VESSEL

(71) Applicants: Benjamin Heidrich, Idar-Oberstein (DE); Andreas Hillenmeier, Ingelheim (DE); Andreas Schmidt, Idar-Oberstein (DE)

(72) Inventors: Benjamin Heidrich, Idar-Oberstein (DE); Andreas Hillenmeier, Ingelheim (DE); Andreas Schmidt, Idar-Oberstein (DE)

(73) Assignee: FISSLER GMBH, Idar-Oberstein (DE)

(21) Appl. No.: 13/997,316

(22) PCT Filed: Nov. 16, 2011
(86) PCT No.: PCT/EP2011/070294

§ 371 Date: Jun. 24, 2013

(30) Foreign Application Priority Data
Dec. 22, 2010 (DE) 10 2010 055 511.8

(51) Int. Cl. A47J 27/62

(52) U.S. Cl. CPC A47J 27/62
USPC 99/331

(57) ABSTRACT

An electronic module for temperature-monitored preparation of food in a cooking vessel, having a base sensor for sensing the temperature of the base of a cooking vessel, and having a communications device for signal transmission of the sensed temperature to a means for controlling or regulating the heating capacity of the cooking point for heating the cooking vessel, where the base sensor has a sensor element, which can be guided into, and out of, a mount in the base of the cooking vessel and is secured in an articulated manner on a housing of the electronic module and is connected to the communications device.

### TECHNICAL FIELD

The invention relates to an electronic module for temperature-monitored preparation of food in a cooking vessel, having a base sensor for sensing the temperature of the base of the cooking vessel, and having a communications device, preferably associated with the base sensor and/or further sensors, for signal transmission of the sensed temperature to a means for controlling or regulating the heating capacity of the cooking point for heating the cooking vessel. The invention also relates to a cooking vessel for use with the electronic module according to the invention.

### BACKGROUND

Various systems for temperature-monitored preparation of food are known, which are also widespread under the concept of “automatic cooking”. A key component of this concept for automatic cooking is the measurement of the temperature of a cooking vessel. It is possible to ascertain the temperature and the cooking state of the food from the measured temperature. The sensed temperature can only be displayed and/or used for automatic regulation of the cooking process provided for the respective food, for example the observance of predefined temperature profiles for different food.

For this purpose, temperature sensors are used that communicate the sensed temperature to a means for regulating or controlling the heating capacity for the cooking vessel. Irrespective of the respective temperature profile, the means for regulating the stove increases or reduces the heating capacity of the cooking point, for example a hob, on the basis of the fed-back actual temperature values in order to adjust the temperature conditions in the cooking vessel to the profile that is optimal for the food.

Here, the measurement of a temperature in the range of the pot base has proven to be rather suitable for a large number of applications, since it is suitable both for roasting and for boiling. In this regard, the combined consideration of the temperature values at the different positions of the cooking pot also provides advantages, because different heat distributions can prevail in the cooking vessel depending on the food/pot content and have to be taken into account during the regulation or control of the heating capacity.

Generally, the quality of the temperature signals is decisive for the success of the automatic cooking process.

The approach known from DE 33 41 234 C1 for implementing an automatic cooking system on the basis of temperature measured values provides a radiation sensor arranged at a distance from the cooking pot and having a focusing device, which is directed to an annularly running radiation area on the cooking pot and measures the temperature on the basis of the radiated electromagnetic radiation, of which the intensity correlates to the temperature.

The apparatus known from DE 38 11 925 C1 for regulating the heating capacity provides a comparable temperature tap. A temperature sensor that functions in the manner of a radiation receiver receives the electromagnetic waves radiated from the pot wall of the cooking vessel. The sensor is coupled via an amplifier to a logic circuit and a power stage in order to adjust the heating capacity. A further sensor is arranged beneath the hot plate and is in heat-conductive contact with the underside of the hot plate. A third sensor is arranged on the outer wall of the cooking pot.

In accordance with the disclosure of DE 35 10 542 A1, which describes a device for controlling the cooking process in a steam pressure cooker, a temperature sensor is integrated into the pot lid and is connected via a cable to a control means of the cooking system.

The cooking stove known from DE 39 28 620 A1 with a means for controlling the energy feed provides a special cooking vessel with an external sensor for measuring the temperature of the food and a sensor for measuring the temperature of the pot base, said sensor being embedded in the pot base. The sensors are connected to an external terminal, which is connected via an electrical connecting cable to the stove, when the cooking vessel is used for cooking with an automatic cooking program sequence. The temperature values are fed to an electronic circuit for regulating the energy feed, which then regulates the heating capacity of the hot plate in order to determine and maintain the cooking temperature and time.

The device known from DE 10 2006 022 327 A1 for controlling and regulating the heating capacity of a hot plate comprises, inter alia, a sensor, which is arranged beneath the cooking vessel and taps the temperature by means of contact with the underside of the cooking vessel. The sensor also comprises means for wireless signal connection, via which the sensor is connected to a control or regulation means, which adjusts the heating capacity of the hob in accordance with the temperature information.

Specifically for measuring the base temperature of the cooking vessel, the known systems provide either temperature sensors, which are fixedly introduced into the cooking vessel or rest on the surface of the vessel base. Introduced sensors increase the cost of each cooking vessel however and also rule out the possibility of retrofitting simple cooking vessels or replacing faulty sensors. Sensors that are not introduced directly into a cooking vessel may be prone to measurement errors, which are caused by soiling, scaling or displacement at the contact point. Ultimately, the regulation quality of the cooking system and the quality of the prepared meals suffer as a result. The necessary fitting of the cooking stove with a temperature sensor at each hob and the respective electronics for forwarding the measured values to the means for regulating the heating capacity has also proven to have an adverse effect. This is cost-intensive and is associated with high effort.

### BRIEF SUMMARY

The invention proposes a possibility for high-quality temperature measurement for the temperature-monitored preparation of food in a cooking vessel, which reduces the effort for the preparation of cooking vessel and cooking stove for automatic cooking and can be used in a versatile manner with different cooking vessels.

Here, in particular, the base sensor comprises a sensor element, which can be guided into, and out of, a mount in the base of the cooking vessel and is secured in an articulated manner on the housing of the electronic module. The base sensor is preferably connected via a cable to the communications device of the electronic module.

In this form, the electronic module constitutes a separate unit that can be detached any time from the cooking vessel and is fitted merely as required on the cooking vessel by inserting the base sensor with the sensor element into the vessel base of the cooking vessel. The electronic module transmits the temperature sensed by the base sensor and possibly further sensors to the means for regulating or controlling the heating capacity.

The electronic module is held on the cooking vessel during operation by insertion of the sensor element of the base sensor, but can also be easily removed again in order to clean the cooking vessel. The articulated connection of the sensor element or base sensor to the electronic module, in particular a hinge joint, ensures that the electronic module can be fitted onto a broad spectrum of pots and pans of different geometry. These merely have to be provided with a suitable mount in the cooking vessel base. This creates the possibility of using a single electronic module for a large number of cooking vessels, even of different shape. The capital costs and the costs for implementing the automatic cooking process are consequently very low.

The temperature tap in the cooking vessel base ensures a high level of accuracy when measuring the temperature in the base region of the cooking vessel and therefore in the direct vicinity of the contact point with the food, wherein the forwarded measured or signal values are used for control purposes in order to ensure a high quality of regulation when adjusting the heating capacity. The electronic module can be used independently of the type of heat feed. It is suitable both for cooking by means of induction and for conventional stove types, for example glass-ceramic or solid hot plates. In addition, the energy costs can be reduced by the high measurement accuracy and the field of use of automated cooking systems can be extended. In this variant, the electronic module is used optimally when roasting and when preparing small contents. For this purpose, the sensing of the base temperature of the cooking vessel is particularly expedient in order to avoid scorching the food.

In accordance with a preferred embodiment of the invention, the sensor element and/or the entire base sensor is/are formed in a rod-shaped manner. A rod-shaped element or a rod-shaped sensor is preferably small in the base area formed transversely with respect to the rod axis, in such a way that it can be inserted into and removed from a bore-like recess in the base of the cooking vessel.

The rod-shaped sensor element may have a round cross section in a simple manner. In order to simultaneously achieve antitwist protection, the rod-shaped element may also have a non-round, in particular non-rotationally symmetrical, cross section, at least in some portions. This can be achieved as a result of the provision of notches, groves, protrusions or the like or an angular, for example square, base area of the rod-shaped element.

The sensor element and base sensor can also be combined in an encapsulated sensor element. Surface wave sensors can also be considered, which for example are connected to a common antenna. In a simple embodiment, the electronic module may also be formed just as a sleeve containing the base sensor with sensor element, said sleeve having an antenna attached to the base sensor.

In accordance with a further advantageous embodiment of the invention, the electronic module can be fastened in a force-locked manner, in particular by means of a magnet, and/or in an interlocked manner, in particular by means of a metal hook and loop fastener, to the outer wall of the cooking vessel. The electronic module can thus be fastened to the cooking vessel and removed therefrom again in a simple manner. Due to this type of fastening, a very simple antitwist protection is also created, which ensures that the elements located in the electronic module are provided with the necessary spacing from the hot plate and cannot be damaged. At the same time, the orientation of the transmitting and receiving devices is defined in a precise manner by the electronic component and means for regulating or controlling the heating capacity.

The type of fastening both by means of insertion of the sensor element connected in an articulated manner to the housing of the electronic module and by force-locked and/or interlocked connection of a fastening portion of the electronic module (magnet, metal hook and loop fastener) also leads to just a low heat exchange from the heated cooking vessel to the electronic module and the electronic components received in the housing of the electronic module. This is advantageous for the function and service life of the electronic components.

In order to cover the broadest spectrum possible of cooking programs and in order to increase the regulation accuracy, in accordance with a particularly preferred embodiment of the invention, the electronic module may comprise at least one further temperature sensor with an associated communications device. In accordance with the invention, the further temperature sensor can be provided to measure the temperature at the outer wall of the cooking vessel.

The further temperature sensor, for example a wall temperature sensor, can preferably be associated with the magnet for fastening the electronic module to the outer wall of the cooking vessel. If the outer wall of the cooking vessel is not magnetic, a magnetic or magnetizable plate, for example made of ferritic steel, can be secured on the outer wall and is generally also a good heat conductor. In accordance with the invention, such a plate can of course also be used when the magnet for fastening the electronic module to the outer wall of the cooking vessel is not associated with a temperature sensor.

The communications device associated with a further sensor may be the communications device that is also associated with the base sensor. Alternatively, one or any further temperature sensor may also be associated with its own communications device. A temperature sensor is electrically conductively and/or heat conductively connected to a communications device. This can be achieved via a cable. It is also possible in accordance with the invention to form the temperature sensor and the associated communications device as an integrated component, for example as a surface acoustic wave sensor (SAW). In particular in the latter case, the integrated temperature sensors with communications devices preferably have a common antenna, via which the data are emitted. Irrespective of the type of sensors, communications devices assigned to one or more sensors can use a common antenna in accordance with the invention.

The provision of a further temperature sensor or a plurality of further temperature sensors advantageously enables the combined use of two or more sensors, which, in addition to a base temperature of the cooking vessel, for example also measure the temperature of the wall of the cooking vessel with a number of sensors, possibly even at different heights. The multiplicity of temperature information can then be evaluated by a means for regulating or controlling the heating capacity means for regulating or controlling the heating capacity, and the preparation temperature that is optimal for the respective food can be set quickly and exactly. The entire preparation process is thus optimized.

Automatic cooking systems with a temperature measurement in the pot base are ideally suited for roasting and boiling because the temperature of the food in many cases can be derived from the temperature of the pot base. These systems tend to heat the food slowly, since they limit the temperature of the pot base.

This has the advantage that, in the case of roasting and boiling, the food does not scorch with little liquid, for example vapors. With increasing filling level and with poor heat conduction of the food, such systems require a very long period however until the desired target temperature is reached throughout the food. For such systems, it is advantageous to additionally measure the temperature of the wall of the cooking vessel and to take this into account during the process of regulating or controlling the heating capacity. This is enabled in accordance with the invention by the electronic module. The electronic module with at least two temperature sensors is therefore also suitable for large filling quantities and for heating meals, for which a multiplicity of temperature sensors is advantageous.

In accordance with a further embodiment of the invention, the communications device is designed for wireless signal transmission. For this purpose, the means for regulating the heating capacity can be equipped with a corresponding signal receiver. It is thus possible to dispense with a cable, which runs from the electronic module to a cooking stove. This facilitates the preparations for the cooking process, and the cable from the cooking vessels to the stove does not pose an obstacle during the cooking process. In addition, the safety is increased by the omission of a flammable cable.

In accordance with the invention, the electronic module is ideally designed passively, that is to say without its own energy supply for example by means of a battery or a power cable. The energy required for the temperature measurement in the electronic module is transmitted for example by inductive coupling in this case with wireless transmission and/or is generated by means of surface acoustic wave technology (SAW). It is also possible for a sensor and a communications device to be formed as an integrated sensor, for example as a surface acoustic wave sensor. This allows an electronically simple construction of the electronic module with simultaneously high reliability of the sensor system.

In accordance with a preferred embodiment of the invention, the communications device can be formed as an RFID chip and/or SAW chip. With these devices, an inductive coupling or surface waves is/are used for wireless transmission and energy recovery for sensors for temperature measurement and signal transmission.

The RFID chip is then preferably connected via a cable to the temperature sensors, in particular the base temperature sensor or the wall temperature sensor. In addition, the RFID chip may comprise an internal temperature sensor for monitoring the temperature of the chip itself. Temperature sensors, in particular the temperature sensors connected to the RFID chip or integrated therein can be formed as a PT1000 resistance thermometer. In accordance with the invention, it is also possible however to form the sensors, for example the wall or base temperature sensors, as thermo elements or other sensors. The RFID chip and the optionally attached temperature sensors are supplied with energy via inductive coupling from a transmitting and receiving device of the hob, said device being formed for example as a read-write unit. The RFID chip radios at regular intervals preferably greater than 1 second the temperature sensed by the sensors as temperature or sensor signal values to the read-write unit or transmitting and receiving device of the hob. An antenna, which is attached to the, or each, RFID chip, can be formed for example as a rectangular copper coil and may have approximately the dimensions of the electronic module, is also integrated into the electronic module. A reliable signal transmission can be achieved with this antenna arrangement.

To this end, in accordance with the invention, an annular antenna coil may be formed in the hob and is connected to the read-write device or transmitting and receiving device of the hob. This preferably has approximately the diameter of the largest pot used and is arranged concentrically with the midpoint of the hob. In the case of hobs comprised of glass ceramics, an arrangement approximately 1 cm beneath the glass-ceramic plate has proven to be expedient in accordance with the invention in order to achieve a good transmitting and receiving power with justifiable heat development. This geometry and arrangement is particularly preferred in order to achieve a reliable radio communication with the RFID chip used.

With the use according to the invention of SAW chips, a temperature sensor, for example the base or the wall temperature sensor, is integrated completely into the SAW chip and housing thereof. In comparable function to the RFID chips, the SAW chips also form the communications device of the electronic module associated with a respective sensor in order to communicate with the read-write unit or transmitting and receiving device of the hob. The SAW chips provided in the electronic component are preferably connected via a cable to a common antenna. Compared to the RFID chips, the SAW chips have the advantage of much better resistance to high temperatures. In the case of a base temperature sensor with a diameter of approximately 3 mm, a temperature resistance up to 350° C., and, in the case of a slightly larger wall temperature sensor, a temperature resistance of 180° C. to 200° C. can thus be achieved. These temperatures are desirable during cooking.

The SAW chip(s) is/are interrogated by the transmitting and receiving device of the cooking point (the hob) by means of radio waves. The radio waves are converted into surface acoustic waves in the SAW chip. These are reflected by the substrate of the chip and are converted again into radio waves. These radio waves are sent back to the transmitting and receiving device of the hob via the attached antenna in the electronic module. The temperature of the substrate can then be ascertained from the response signal, for example via the time lag of the echo.

Once the temperature or signal values have been received, the read-write unit forwards these to the means for controlling or regulating the heating capacity of the cooking point (or of the hob), which then adjusts the capacity of the hob in accordance with predefined cooking programs and/or cooking programs selected or parameterized by the user. An optimized temperature for the selected dish can therefore be set in the cooking vessel.

A transmission frequency of the signal that is suitable in accordance with the invention may lie at 12 to 14 MHz, for example at 13.56 MHz or 433 MHz, or in the region of 2.4 GHZ. In principle, a person skilled in the art is free to select a suitable transmission frequency within the scope of conventional technologies.

In accordance with an expedient embodiment of the invention, the electronic module is permeable to radio waves at least in portions, in particular in the direction of the signal receiver and/or the cooking point (that is to say towards the side facing away from the pot surface during use), that is to say is preferably not made from conductive metal, in order to not dampen the transmission signals. The smallest distance possible is advantageously present between the communications device and a signal receiver of the means for controlling and/or regulating the stove when the electronic module is fastened to the cooking vessel and the cooking vessel is located on the cooking point. This ensures a reliable radio transmission path.

In order to further improve the automatic cooking and the regulation or control of the heating capacity, the electronic module may further comprise a connection for an external temperature sensor, for example a core thermometer for direct measurement of the food in the cooking vessel. This can be formed as a cabled connection, but also as a wireless connection. The quality of the automatic cooking process can thus be improved further. Here, it is advantageous for the communication with the means for regulating or controlling the heating capacity of the cooking point if the signal of this temperature sensor is also transmitted by the electronic module, because a good receivability comparable to the other temperature signals is thus achieved. In the case of a wireless communications connection of the external temperature sensor to the electronic module, this may take on the function of a router and reliably forwards the signal exiting from the well-shielded pot interior.

The invention also relates to a cooking vessel for use with the above-described electronic module according to the invention and comprises in its base a mount for the base sensor or the sensor element of the base sensor. This can be produced in a simple manner by a bore or the like. Here, a viewpoint that should not be neglected is the possibility for retrofitting offered by the invention for automatic cooking with regard to simple cooking vessels. These do not have to be provided with electronic components, but merely with a mount for the base sensor. This signifies a significant potential cost saving when purchasing, or existing cookware can be retrofitted for use with the electronic module according to the invention, for example by a service procedure. This is also expedient from financial viewpoints, at least in the case of high-quality cookware.

For the mount, a depth from 20 to 70 mm, preferably from 30 to 60 mm may be provided, wherein the maximum depth of the mount should not exceed half the diameter of the vessel base in order to rule out inaccuracies caused by edge effects at the edge of the cooking vessel base. This ensures an effective measurement of the actual temperature conditions in the vessel base with sufficient stability of the cookware. At the same time, the electronic module and in particular the sensor element of the base sensor can be formed in a small manner and produced cost effectively.

Particular advantages are provided if the mount comprises a sleeve arranged in the vessel base, in particular a stainless steel sleeve welded to the vessel base. Particularly with cooking vessels with an aluminum core, this variant prevents corrosion in the mount and thus enables the cooking vessel to be cleaned in a dishwasher.

In accordance with a development of the inventive concept, the mount may also be formed with an antitwist protection. This may have an angular shape for example or a guide (groove, pin or the like) and thus ensures that the electronic module does not pivot towards the hob, but is always secured in its position against rotation. The base sensor advantageously has a shape corresponding to the mount.

In accordance with a further advantageous embodiment, the outer wall of the cooking vessel comprises elements for force-locked and/or interlocked fastening of the electronic module, in particular a fastenable plate made of ferritic steel or a metal and/or magnetic hook and loop fastener. A plate can be fastened on the outer wall for example by means of welding or adhesive bonding. The fastening element not only constitutes an antitwist protection, but may also form a further measurement point for a temperature sensor on the outer wall of the cooking vessel. The fastening element may be designed such that the temperature sensor bears directly against the outer wall or the plate or taps the temperature via the fastening element. The manufacturing costs for a plate according to the invention are low and any cooking vessel can be retrofitted with this fastening element with low effort.

Connection options for further, external temperature sensors, which are preferably also associated with the electronic module according to the invention in such a way that the transmission signals of the external temperature sensor are transmitted via the electronic module to the means for regulating or controlling the heating capacity of the cooking point, may also be provided within the cooking vessel. For example, it is thus possible to insert a roasting sensor directly into the roasted food or to immerse a sensor in liquid foodstuff. The temperature signals are then transmitted via the electronic module to the means for regulating the heating capacity. A particularly high quality of the cooking process is achieved by the combination of the various temperature signals. The connection option may be a connection for insertion of a cabled temperature sensor. It is also conceivable however to form the connection option as an antenna aperture through a cooking vessel wall shielding wireless transmission signals and additionally to enable a wireless connection of the further temperature sensor to the electronic module.

### BRIEF DESCRIPTION OF THE DRAWINGS

Further features, advantages and possible applications of the invention will emerge from the following description of exemplary embodiments and from the drawing. Here, all described and/or schematically illustrated features form the subject of the invention, either individually or in any combination and independently of their summary in the claims or the back-references thereof.

In the drawing:

FIG. 1 shows a perspective view of the electronic module according to the invention with folded-in face base sensor;

FIG. 2 shows the electronic module according to FIG. 1 with folded-out base sensor;

FIG. 3 shows a detailed view of the pot wall of a cooking vessel according to the invention for fastening of the electronic module according to FIG. 1;

FIG. 4 shows a sectional view of the electronic module according to FIG. 1 secured on the wall of the cooking vessel according to FIG. 3; and

FIG. 5 shows a perspective view of the electronic module secured on the wall of the cooking vessel in accordance with FIG. 4.

### DETAILED DESCRIPTION

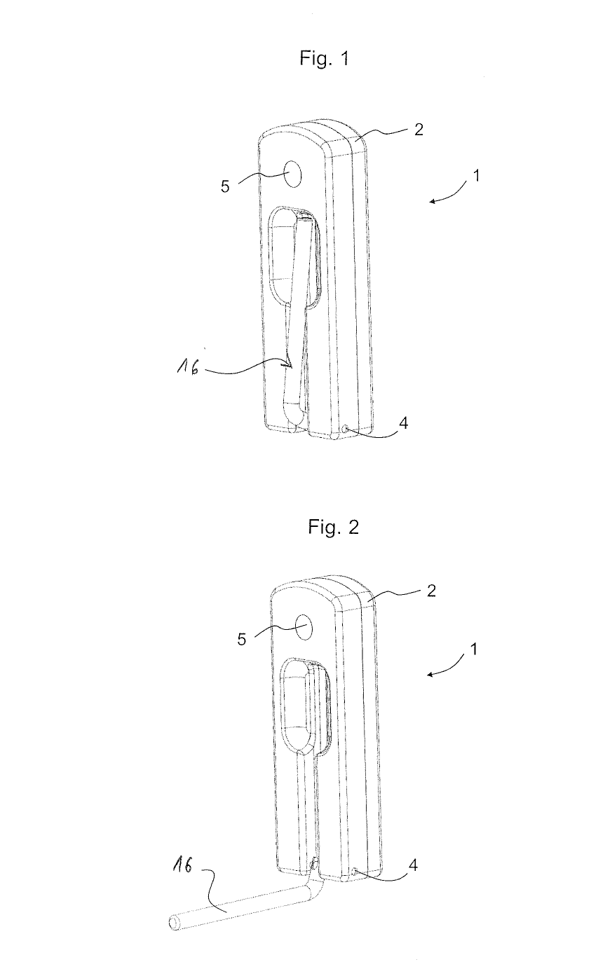

The electronic module 1 illustrated in FIG. 1 comprises an elongate housing 2 and a base sensor 3 for temperature measurement. The base sensor 3 is for this purpose equipped with a sensor element 16, which can be introduced into a recess in a base of a cooking vessel. To protect the actual sensor against infiltrating moisture or damage, the base sensor 3 or the sensor element 16 is formed in an encapsulated manner and likewise has an elongate form, which can be easily introduced into a recess of the cooking vessel and removed therefrom again. The base sensor 3 is connected to the housing 2 via a hinge joint 4.

In the upper region of the electronic module 1 opposite the hinge joint 4, a further temperature sensor 5 is provided, which is substantially flush with the surface of the housing 2 or protrudes slightly beyond this surface. FIG. 1 shows the electronic module 1 in the folded-in state, in which the base sensor 3 or the sensor element 16 of the base sensor 3 is folded towards the housing 2 via the hinge joint 4 and is received in a central portion in a recess of the housing 2. In the folded-in state, the electronic module 1 thus adopts a small and compact form.

For cooking or fitting on the cooking vessel, the base sensor 3 is pivoted out from the recess, as illustrated in FIG. 2. The electronic module 1 can then be fitted on a cooking vessel by inserting the base sensor 3 or the sensor element 16 thereof into a mount in the base of the cooking vessel.

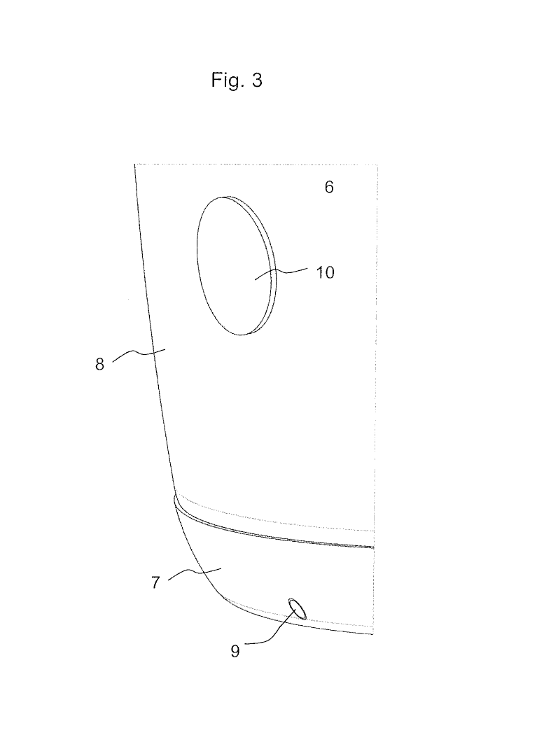

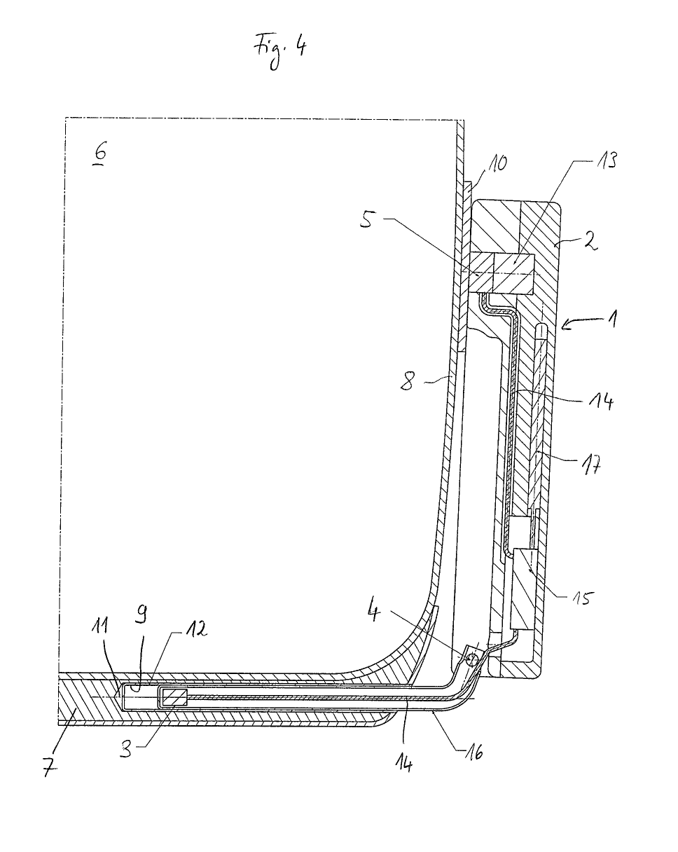

FIG. 3 shows a detailed portion of the base-side (lower) region of a side portion of a cooking vessel 6 formed as a cooking pot with a pot base 7 and pot wall 8 extending (upwardly) from the pot base 7. A mount 9 formed as an opening or bore for the rod-shaped base sensor 3 or the sensor element 16 thereof, which extends radially into the pot base 7, is located laterally in the pot base 7. A plate 10 made of ferritic or magnetic steel is fastened to the pot wall 8 above the mount 9, for example by means of welding or adhesive bonding. The plate 10 is used, inter alia, to fix the electronic module 1 on the cooking pot 6, which is formed magnetically in the region of the further temperature sensor 5 and can thus be secured on the plate 10, which is likewise magnetic or magnetizable. The plate 10, starting from the recess 9, is preferably arranged on the pot wall 8 above the recess 9 in the vertical direction, in such a way that an extension of the connecting line between the recess 9 and the plate 10 running over the pot surface meets at right angles (based on the direction of the pot surface) a plane defined by the footprint of the pot.

For a cooking process, the electronic module 1 is fastened to the cooking pot 6, as illustrated in FIG. 4, by inserting the sensor element 16 with the base sensor 3 (base temperature sensor) into the mount 9 of the pot base 7. To this end, a bore 11 of the mount 9 runs from the side wall of the pot base 7 radially in the direction of the center of the pot. A sleeve 12 made of stainless steel is introduced into the bore 11 and is laser-welded to the pot base 7, whereby said pot base is protected against corrosion. The pot with the mount 9 is thus also dishwasher-suitable.

The base sensor 3 is in heat conductive contact with the sleeve 12, whereby a high measurement accuracy is ensured. In addition, the electronic module 1 is fixed both horizontally and vertically by the fit between the sleeve 12 and the base sensor 3 or the sensor element 16.

The housing 2 of the electronic module 1 is folded via the hinge joint 4 onto the pot wall 8, whereby the temperature sensor 5 (wall sensor) bears against the plate 10. Behind the temperature sensor 5, a magnet 13 is arranged in the housing 2 and cooperates in a force-locked manner with the plate 10. On the one hand, the housing 2 is thus fastened to the pot wall 8, and on the other hand an antitwist protection is produced, which prevents the housing 2 from pivoting about the bore 11 or the recess 9. Alternatively, the antitwist protection can also be achieved by means of a guide in the recess 9, for example by means of a non-rotationally symmetrical cross section.

A cable 14 connects the base sensor 3 to an RFID chip 15 in the housing 2, wherein the cable 14 is provided with a strain relief (not illustrated) in order to compensate for and secure the pivoting motion of the base sensor 3 relative to the housing 2. The RFID chip 15 takes on the function of the communications device (radio chip), which is interrogated by a suitable transmitting and receiving device, for example in the hob of the stove. To this purpose, the transmitting device of the hob addresses the radio chip 15 and in so doing induces electrical energy in the radio chip 15, which, by means of this induced energy, interrogates the base sensor 3 via the cable 14 and emits again the received signal. This signal is then received by the receiving device of the hob.

Due to this embodiment of base sensor 3 and radio chip 15, which together form a sensor element, the electronic module 1 in accordance with the invention can be formed for example as a passive component without an independent energy supply, for example in the form of a battery or a connecting cable to an external voltage source.

In the case of a SAW sensor, the sensor 3, 5 and the radio chip 15 are integrated in a housing. In the illustration according to FIG. 4, the separate radio chip 15, which is received in the housing 3, 5 at the indicated position, is then omitted.

An antenna 17 common for all sensors 3, 5 is attached to the radio chip 15, irrespective of whether said chip is integrated into the housing of the sensors 3, 5 or is formed separately, as illustrated.

Due to the transmitting power only available to a limited extent in the case of passive sensor elements, the radio chip 15 and the antenna 17 are preferably received in the region of the housing 2 facing towards the hob with the transmitting and receiving device (and the wall 8 of the cooking vessel 6).

The same applies accordingly for the aforementioned further temperature sensor 5. This is connected via a corresponding cable 14 to the radio chip 15 formed as an RFID chip.

In principle, deviating from the illustrated embodiment, the wall temperature sensor 5 could also have its own radio chip or its own communications device, which preferably also functions passively however, that is to say the energy required for the signal transmission and optionally the temperature measurement is obtained from the inquiry by the transmitting device, for example by inductive coupling to the transmitting and receiving device (not illustrated) in the region of the cooking field, or by surface wave sensor technology.

In order to ensure a reliable signal transmission, the housing 2 in the wall region facing towards the hob or the transmitting and receiving device thereof (that is to say the wall opposite the wall 8 of the cooking vessel 6) and/or in the base region is permeable to radio waves wherein the housing is heat resistance and water-tight in order to protect the electronics. Plastic lends itself for this purpose. The described arrangement for the radio chip 15 and of the short distance associated therewith to the signal receiver contribute to the high signal quality.

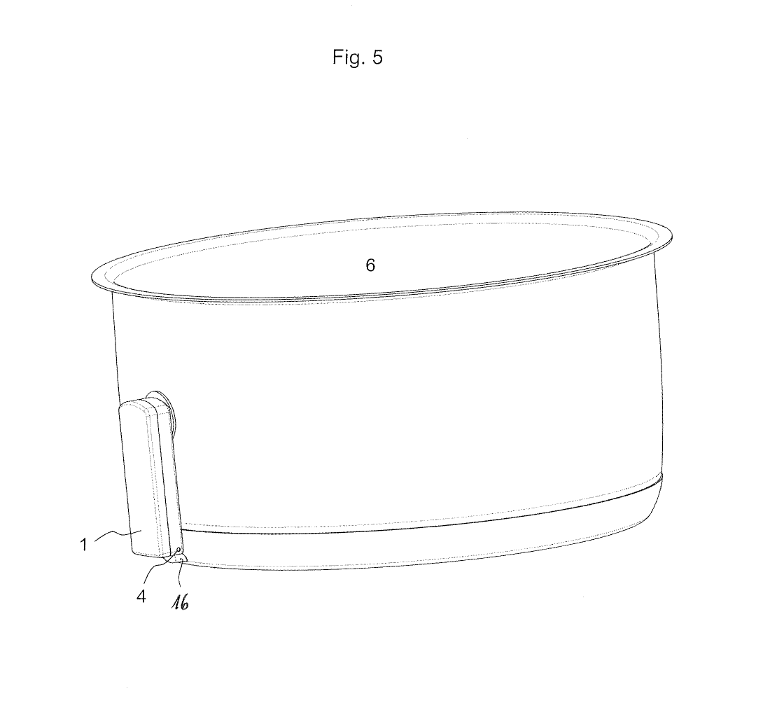

The electronic module 1 fitted on the cooking pot 6 is shown in FIG. 5. The electronic module 1 has approximately the size and shape of a commercially available USB stick and is relatively small, yet still slip-proof, compared to the cooking vessel 6 formed as a cooking pot, such that it can be fastened easily and quickly to the cooking pot 6 and removed therefrom. As can be seen from FIG. 5, the electronic module 1 has adapted to the outer shape of the cooking pot 6 by means of the hinge joint 4. The outer wall of the cooking pot 6 can also be considerably more slanted, as is the case with a wok for example. The electronic module 1 also adapts to this outer shape via the hinge joint 4.

If the cooking pot 6 is placed on the hob of a stove prepared for automatic cooking and if heat is introduced into the pot base 7, the base sensor 3 measures the heat of the pot base 7 and wirelessly communicates the measured temperature value in the form of a suitable signal back to the means for regulating the heating capacity of the stove. At the same time, the temperature sensor 5 fitted on the pot wall 7 measures the heating of the pot wall 7, wherein this temperature value is also transmitted to the means for regulating the heating capacity of the stove. Depending on the cooking program and the desired cooking result, the means for regulating or controlling the heating capacity suitably adjusts the heating capacity of the cooking field under consideration of the temperature signals sensed and transmitted by the temperature sensors 3, 5 of the electronic module 1.

Once the automatic cooking process is complete, the cooking pot or the cooking vessel 6 can be easily cleaned by removing the electronic module 1. This can then be used easily on another cooking vessel 6, such that it is sufficient to have available a number of electronic modules 1 matching the number of cooking points, without each cooking vessel 6 itself having to be equipped with its own electronic module 1. In order to avoid corrosion in the sleeve 12, the mount 9 or sleeve 12 when the electronic module 1 is removed can be closed in accordance with the invention, for example by means of a closure stopper, which may preferably be formed of silicone. The closure seals the mount 9, preferably in a water-tight manner, such that no moisture infiltrates when the cooking vessel is cleaned.

1. An electronic module for temperature-monitored preparation of food in a cooking vessel, comprising:
a base sensor for sensing the temperature of the base of a cooking vessel, and
a communications device for signal transmission of the sensed temperature to a means for controlling or regulating the heating capacity of the cooking point for heating the cooking vessel,
wherein the base sensor comprises a sensor element, which can be guided into, and out of, a mount in the base of the cooking vessel and is secured in an articulated manner on a housing of the electronic module and is connected to the communications device.

2. The electronic module according to claim 1, wherein the sensor element is rod-shaped.

3. The electronic module according to claim 1, wherein the housing of the electronic module can be fastened in a force-locked manner, by a magnet, and/or in an interlocked manner by means of a metal hook and loop fastener, to an outer wall of the cooking vessel.

4. The electronic module according to claim 1, wherein the electronic module comprises at least one further temperature sensor with an associated communications device.

5. The electronic module according to claim 4, wherein the communications device is designed for wireless signal transmission.

6. The electronic module according to claim 5, wherein the housing of the electronic module is permeable to radio waves.

7. The electronic module according to claim 1, wherein the electronic module comprises a connection for at least one external temperature sensor.

8. A cooking vessel for use with an electronic module according to claim 1, wherein the base of the cooking vessel comprises a mount for the sensor element of the base sensor.

9. The cooking vessel according to claim 8, wherein the mount has a depth from 20 to 70 mm, the maximum depth not exceeding half the diameter of the base.

10. The cooking vessel according to claim 8, wherein the mount comprises a sleeve arranged in the base.

11. The cooking vessel according to claim 8, wherein the mount is formed with an antitwist protection.

12. The cooking vessel according to claim 8, wherein the outer wall of the cooking vessel comprises elements for force-locked and/or interlocked fastening of the electronic module.

13. The cooking vessel according to claim 8, wherein connection options for temperature sensors are provided within the cooking vessel.

14. The cooking vessel according to claim 8, wherein the mount can be closed.
